(19) United States
(12) Patent Application Publication
(10) Pub. No.: US 2008/0310095 A1
(43) Pub. Date: Dec. 18, 2008

(54) Multi-stack storage module board assembly

(75) Inventors: Hsuan-Chan Chiang, Yungho City (TW); Yu-Shu Kao, Panchiao City (TW)

Correspondence Address: BACON & THOMAS, PLLC, 625 SLATERS LANE, FOURTH FLOOR, ALEXANDRIA, VA, 22314-1176, US

(73) Assignee: ADLINK TECHNOLOGY INC., Chungho City (TW)

(21) Appl. No.: 11/808,612

(22) Filed: Jun. 12, 2007

(51) Int. Cl. G06F 1/16

(52) U.S. Cl. 361/685

(57) ABSTRACT

A multi-stack storage module board assembly includes a host board having an electric connector, multiple brackets mounted on the host board and fastened to one another in a stack, multiple multimedia storage devices respectively mounted in the brackets, and adapter modules mounted on support arms in the brackets to electrically connect the multimedia storage devices to the connector of the host board. Each adapter module has a first connector, which receives one multimedia storage device, a second connector connectable to the connector of the host board, and a third connector for receiving the second connector of another adapter module.

### BACKGROUND OF THE INVENTION

1. Field of the Invention

The present invention relates to a storage module board assembly and more particularly, to a multi-stack storage module board assembly, which allows installation of multiple multimedia storage devices of same or different specifications on one single host board to realize high-quality signal transmission and to save the installation space.

2. Description of the Related Art

Following fast development of computer technology, sophisticated high-power high-speed computers have been continuously created. Further, industrial computers are firstly used in factory automation at the control center of a CNC (Computer Numerical Control) controller, CNC lathe or CNC milling machine, for controlling, monitoring or testing the machine or instrument in a production flow. Following progress in PC (personal computer) industry and standardization and population of computer platform, PC architecture has been intensively used in industrial automation control systems. Therefore, industrial computer manufacturers utilize the abundant PC software and hardware resources to match with different motherboards, chips, shells, connectors and operation systems, so as to satisfy different operation environment requirements (requirements for humility, the performance of the protectivity against dust, fault tolerance, voltage stabilizer, uninterrupted power supply system, and etc.). Industrial computer market has the characteristic of multiple patterns and small quality. In addition to industrial application, industrial computers are now widely used in many other fields, such as banking services, telecommunication networks, computer automation controllers and servers for public environmental applications (such as, mass transportation card readers, automatic ticket vending machines, auto teller machines, point of sale systems, KTV music player, freeway LED display systems, integrated computer and telephone systems, national defense and navigation systems, etc.).

Further, disk arrays are developed to satisfy the demand of server systems and professional audio and video providers and to meet network application environment requirements. A disk array is a requisite equipment in a middle/high level application environment. An early design of hard disk drive adopts IDE interface, which was created to standardize the use of hard disk drives in computers. Thereafter, E-IDE interface and ATAPI E-IDE interface are developed subject to the development of CD-ROM drive. An IDE interface occupies a lot of CPU resources during data transmission, thereby affecting the whole system operation speed.

In order to support various peripheral devices and to improve the transmission speed and system efficiency, computer motherboard with SCSI (Small Computer System Interface) is created. If a regular computer motherboard without SCSI is to be provided with a SCSI interface, a SCSI interface card must be used. However, a SCSI interface card is expensive. Further, it is complicated to install a SCSI interface card in a computer motherboard. The setting of the installed SCSI interface card is also complicated.

Further, following increasing of working frequency, signal interference becomes more serious in parallel transmission. When compared to a parallel ATA (PATA) interface, a SATA interface has less signal voltage and less number of pins for high performance application. SATA interface also has much higher transmission rates. Because of LVDS (Low Voltage Differential Signaling) technology, SATA interface has the advantages of low power consumption, low electromagnetic interference and high signal stability. Soon after introduction of SATA interface, SATA-II interface is developed to double the transmission speed.

Further, in order to improve storage system performance, extendability and reliability, SAS interface is created after introduction of SCSI interface. SCSI interface is compatible with lower-cost-per-gigabyte SATA and SATA-II drives as well as SAS drives. Further, SATA interface is limited to motherboard chip. The multi-mode application feature of SCSI interface allows for better performance and adding to a second connection port to hard disk to enhance system applicability and reliability.

In the server system of an industrial computer, the limited surface space of the circuit board does not allow for installation or replacement of many different storage modules of different transmission formats. Therefore, the number of storage modules (hard disk, CD-ROM) on the circuit board of an industrial computer is limited, and the related transmission formats (IDE, SCSI, SATA, SATA-II, SAS, USB) are also limited. When adding an extra storage module to an industrial computer, an extra circuit board must be used to carry the added storage module in the industrial computer. This installation procedure is complicated and not cost-effective. Further, when many circuit boards with many storage modules are used, the connection bus lines or cables among the circuit boards limit the transmission efficiency and may cause impedance interference. Further, the connections bus lines or cables may be stretched accidentally, resulting in signal transmission failure.

Therefore, it is desirable to provide a multi-stack storage module board assembly that allows installation of multiple multimedia storage devices of same or different specifications on one single host board to realize high-quality signal transmission and to save the installation space.

### SUMMARY OF THE INVENTION

The present invention has been accomplished under the circumstances in view. It is one object of the present invention to provide a multi-stack storage module board assembly, which uses adapter modules to connect multiple multimedia storage devices to one host board, so that the non-linear connection design of the adapter modules eliminates the problem of limitation of transmission efficiency, impedance interference or accidental interruption of signal transmission due to the use of bus lines or cables, achieving rapid and stable transmission quality and high reliability. It is another object of the present invention to provide a multi-stack storage module board assembly, which uses adapter modules and brackets to hold multiple multimedia storage devices on one single host board, so that different multimedia storage devices having different transmission standards can be selectively and replaceably installed in one single host board to satisfy different application requirements. It is still another object of the present invention to provide a multi-stack storage module board assembly, which allows multiple multimedia storage devices to be mounted on one single host board, saving much installation space.

To achieve these and other objects of the present invention, the multi-stack storage module board assembly comprises a host board, which has a connector, a plurality of brackets arranged on the host board in one stack or two stacks, multimedia storage devices respectively mounted in the brackets, and adapter modules respectively installed in the brackets and connected to one another in a stack to electrically connect the multimedia storage devices to the connector of the host board so that the host board is accessible to the multimedia storage devices.

### BRIEF DESCRIPTION OF THE DRAWINGS

FIG. 1 is an exploded view showing the basic structure of a multi-stack storage module board assembly according to the present invention.

FIG. 2 is an elevational assembly view of FIG. 1.

FIG. 3 is an exploded view of a multi-stack storage module board assembly in accordance with a first embodiment of the present invention.

FIG. 4 is an elevational assembly view of the multi-stack storage module board assembly in accordance with the first embodiment of the present invention.

FIG. 5 is an exploded view of a multi-stack storage module board assembly in accordance with a second embodiment of the present invention.

FIG. 6 is an elevational assembly view of the multi-stack storage module board assembly in accordance with the second embodiment of the present invention.

FIG. 7 is an exploded view of a multi-stack storage module board assembly in accordance with a third embodiment of the present invention.

FIG. 8 is an elevational assembly view of the multi-stack storage module board assembly in accordance with the third embodiment of the present invention.

FIG. 9 is an exploded view of a multi-stack storage module board assembly in accordance with a fourth embodiment of the present invention.

FIG. 10 is an elevational assembly view of the multi-stack storage module board assembly in accordance with the fourth embodiment of the present invention.

FIG. 11 is an exploded view of a multi-stack storage module board assembly in accordance with a fifth embodiment of the present invention.

FIG. 12 is an elevational assembly view of the multi-stack storage module board assembly in accordance with the fifth embodiment of the present invention.

FIG. 13 is an exploded view of a multi-stack storage module board assembly in accordance with a sixth embodiment of the present invention.

FIG. 14 is an elevational assembly view of the multi-stack storage module board assembly in accordance with the sixth embodiment of the present invention.

FIG. 15 is an exploded view of a multi-stack storage module board assembly in accordance with a seventh embodiment of the present invention.

FIG. 16 is an elevational assembly view of the multi-stack storage module board assembly in accordance with the seventh embodiment of the present invention.

### DETAILED DESCRIPTION OF THE PREFERRED EMBODIMENT

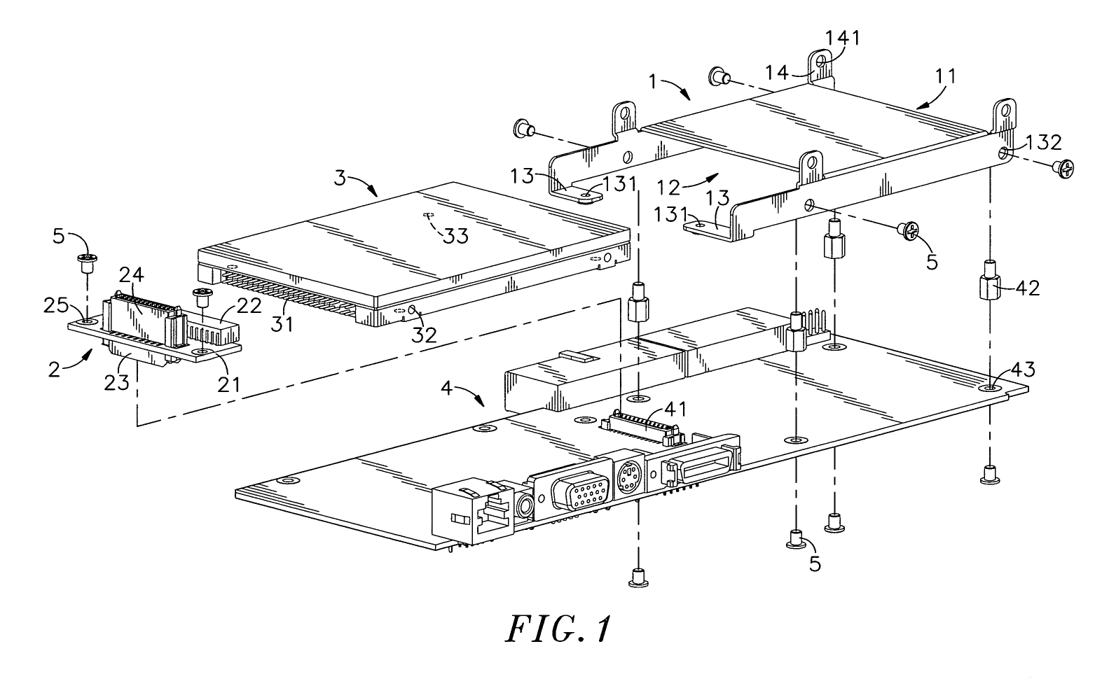

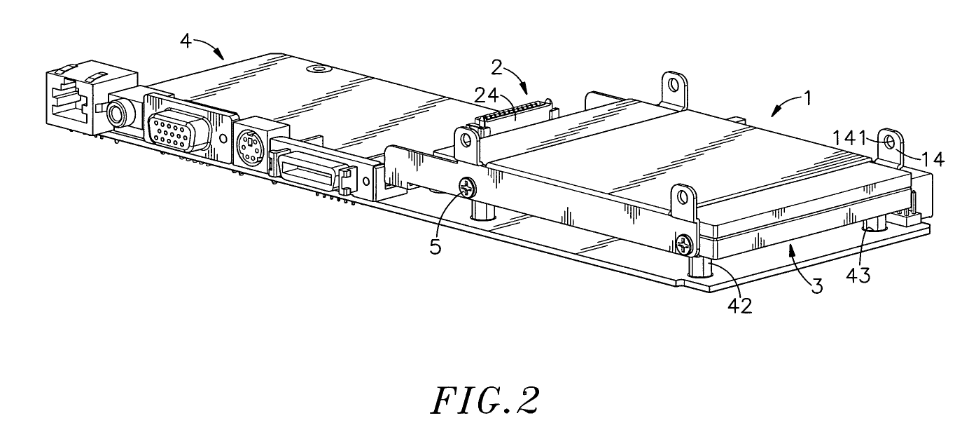

Referring to FIGS. 1 and 2, the present invention basically comprises a bracket 1, an adapter module 2, a multimedia storage device 3 and a host board 4.

The bracket 1 defines a first receiving space 11 for receiving the multimedia storage device 3 and a second receiving space 12 in communication with the first receiving space 11 at one side for receiving the adapter module 2. Further, the bracket 1 has a plurality of mounting holes 132 on two opposite sidewalls thereof, and two support arms 13 respectively inwardly extending from one end of each of the two opposite sidewalls and suspending in the second receiving space 12 at the bottom. The support arms 13 each have a mounting through hole 131.

The adapter module 2 comprises a printed circuit board 21, a first connector 22 horizontally arranged on the top side of the printed circuit board 21, a second connector 23 downwardly extending from the bottom side of the printed circuit board 21, a third connector 24 upwardly extending from the top side of the printed circuit board 21, and two through holes 25 cut through the printed circuit board 21 corresponding to the mounting through holes 131 of the support arms 13.

The multimedia storage device 3 has a signal connector 31 disposed at one side for receiving the first connector 22 of the adapter module 2, a plurality of receiving holes 32 disposed at two sides corresponding to the mounting holes 132 of the bracket 1, and a plurality of locating holes 33 on the bottom side.

The host board 4 comprises a connector 41 for receiving the second connector 23 of the adapter module 2, a plurality of holes 43 corresponding to the locating holes 33 of the multimedia storage device 3, and a plurality of spacer supports 42 respectively engaged into the locating holes 33 of the multimedia storage device 3 and fastened to the holes 43 to support the multimedia storage device 3 above the host board 4.

During installation, the adapter module 2 is set in the second receiving space 12 and supported on the support arms 13, and then fastening members 5 are fastened to the through holes 25 of the adapter module 2 and the mounting through hole 131 of the support arms 13 to affix the adapter module 2 to the bracket 1, and then the multimedia storage device 3 is inserted into the first receiving space 11 inside the bracket 1 to force the signal connector 31 into connection with the first connector 22 of the adapter module 2, and then fastening members 5 are fastened to the mounting holes 132 of the bracket 1 and the receiving holes 32 of the multimedia storage device 3 to affix the multimedia storage device 3 to the bracket 1, and then the spacer supports 42 are respectively inserted into the locating holes 33 of the multimedia storage device 3, and then the second connector 23 of the adapter module 2 is connected to the connector 41 of the host board 4 and the spacer supports 42 are respectively attached to the holes 43, and then fastening members 5 are fastened to the holes 43 and the spacer supports 42 to affix the spacer supports 42 to the host board 4. When installed, the multimedia storage device 3 is supported on the spacer supports 42 above the host board 4, and kept steadily in horizontal.

The first connector 22 of the adapter module 2 can be an IDE, SCSI, SATA, SATA-II, SAS or USB plug. The multimedia storage device 3 can be a floppy disk drive, hard disk drive, CD-ROM, CD-RW, tape drive or any of a variety of electronic devices that have a storage interface. A hard disk drive for the multimedia storage device 3 can be a storage device with an IDE, SCSI, SATA, SATA-II, SAS or CF interface. Further, the bracket 1 fits the shape, size or thickness of the multimedia storage device 3. The bracket 1 can also be made to hold any of a variety of the aforesaid different types of multimedia storage devices 3. The aforesaid fastening members 5 can be screws, rivets or other equivalent devices.

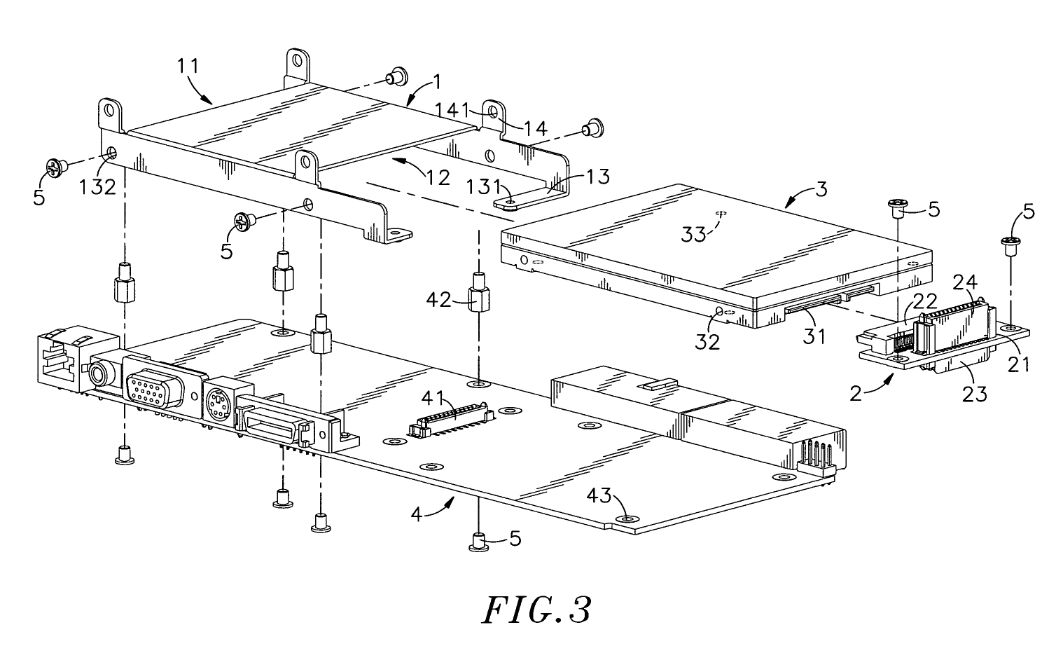

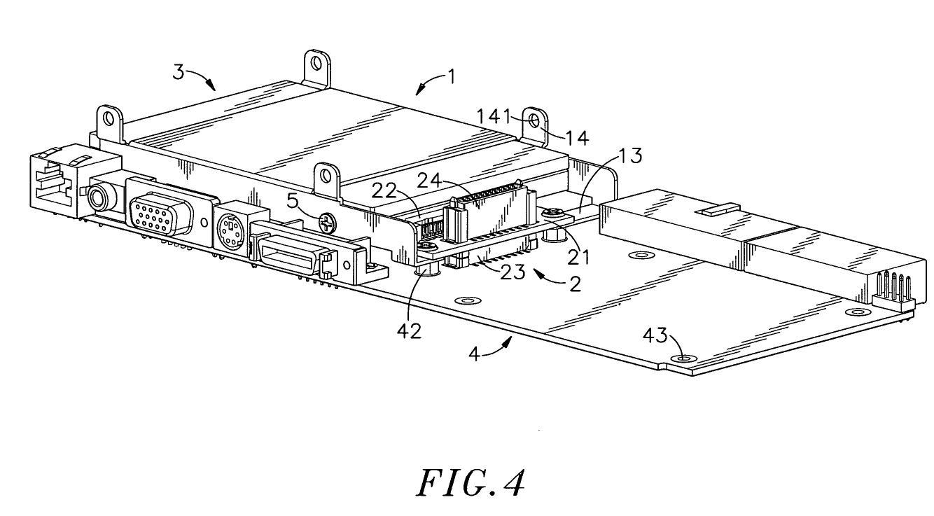

FIG. 3 is an exploded view of a multi-stack storage module board assembly in accordance with a first embodiment of the present invention. FIG. 4 is an elevational assembly view of the multi-stack storage module board assembly in accordance with the first embodiment of the present invention. According to this first embodiment, the first connector 22 is a SATA connector; the multimedia storage device 3 is a SATA hard disk drive connected to the SATA connector 22 of the adapter module 2; the bracket 1 fits a SATA hard disk drive in size. After connection of the second connector 23 of the adapter module 3 to the connector 41 of the host board 4, the multimedia storage device 3 is electrically connected to the host board 4.

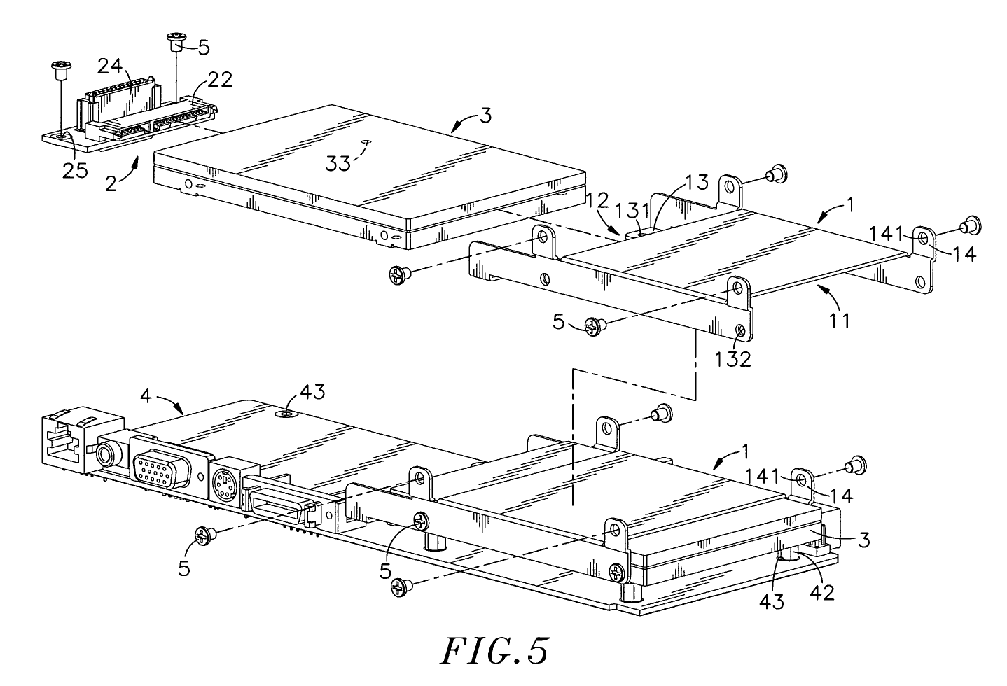

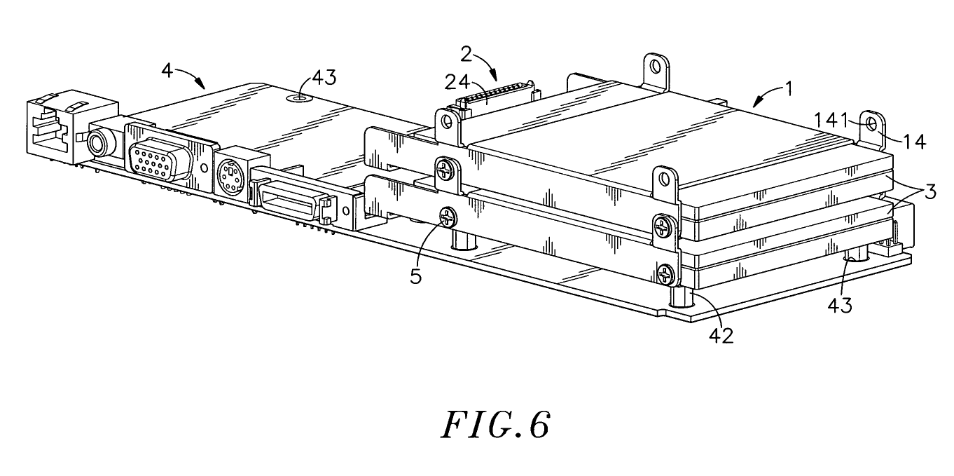

FIGS. 5 and 6 show a multi-stack storage module board assembly in accordance with a second embodiment of the present invention. According to this second embodiment, two brackets 1 are arranged in a stack on the spacer supports 42 above the host board 4 to hold a respective adapter module 2 and a respective multimedia storage device 3, and the two adapter modules 2 are connected together to electrically connect the multimedia storage devices 3 to the connector 41 of the host board 4. Each bracket 1 further has a plurality of upright lugs 14 corresponding to the mounting holes 132. Each upright lug 14 has a locating through hole 141.

During installation, a first one of the multimedia storage devices 3 is fastened to a first one of the brackets 1 and connected to the first connector 22 of the associating adapter module 2, and then the second connector 23 of the adapter module 2 is connected to the connector 41 of the host board 4 for enabling the associating multimedia storage device 3 to be positively supported on the spacer supports 42 at the host board 4, and then the receiving holes 32 of the second one of the multimedia storage devices 3 are fastened to the mounting holes 132 of the second one of the brackets 1 and the locating through holes 141 of the lugs 14 of the first one of the brackets 1 with fastening members 5, for enabling the second connector 23 of the second one of the adapter modules 2 to be connected to the third connector 24 of the first one of the adapter modules 2 to electrically connect the second one of the multimedia storage devices 3 to the host board 4.

According to this second embodiment, the first connector 22 of each adapter module 2 can be an IDE, SCSI, SATA, SATA-II, SAS or USB plug. Each multimedia storage device 3 can be a floppy disk drive, hard disk drive, CD-ROM, CD-RW, tape drive or any of a variety of electronic devices that have a storage interface. In case a hard disk drive is used for each multimedia storage device 3, it can be a storage device with an IDE, SCSI, SATA, SATA-II, SAS or CF interface. Further, the brackets 1 fit the respective multimedia storage devices 3 in shape, size or thickness.

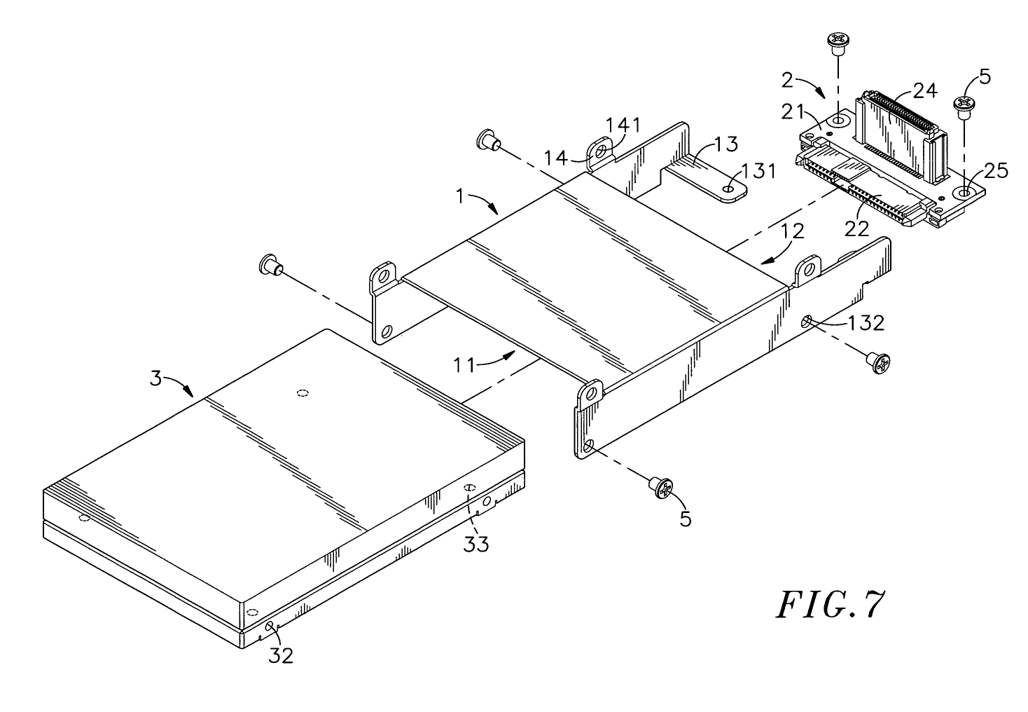

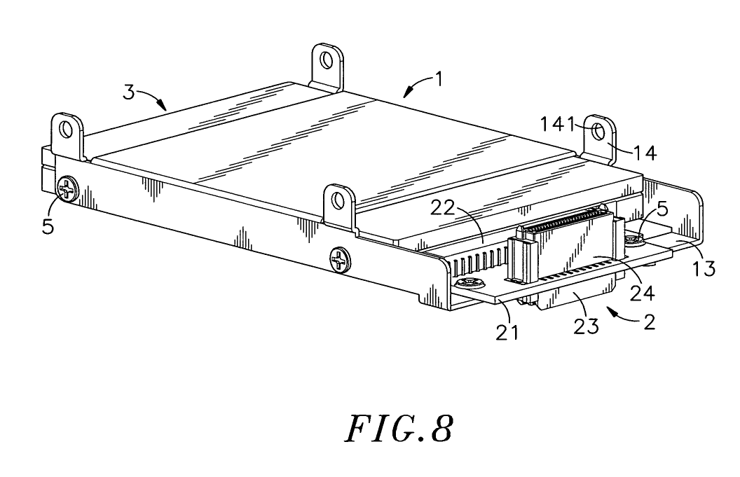

FIGS. 7 and 8 show a multi-stack storage module board assembly in accordance with a third embodiment of the present invention (the host board excluded). According to this third embodiment, the multimedia storage device 3 is a SAS hard disk drive, and the bracket 1 fits a SAS hard disk drive in shape, size and/or thickness. The multimedia storage device 3 is connected to the SAS interface type first connector 22 of the adapter module 2. The second connector 23 of the adapter module 2 is compatible to the third connector 24 so that the second connector 23 of one adapter module 2 can be electrically connected to the third connector 24 of another adapter module 2. Similar to the aforesaid first and second embodiments, the bracket 1 has upright lugs 14, and each upright lug 14 has a locating through hole 141. Thus, multiple brackets 1 can be connected in a stack to hold multiple multimedia storage devices 3 at different elevations. By means of the associating adapter modules 2, the stacked multimedia storage devices 3 are electrically connected to the host board (not shown).

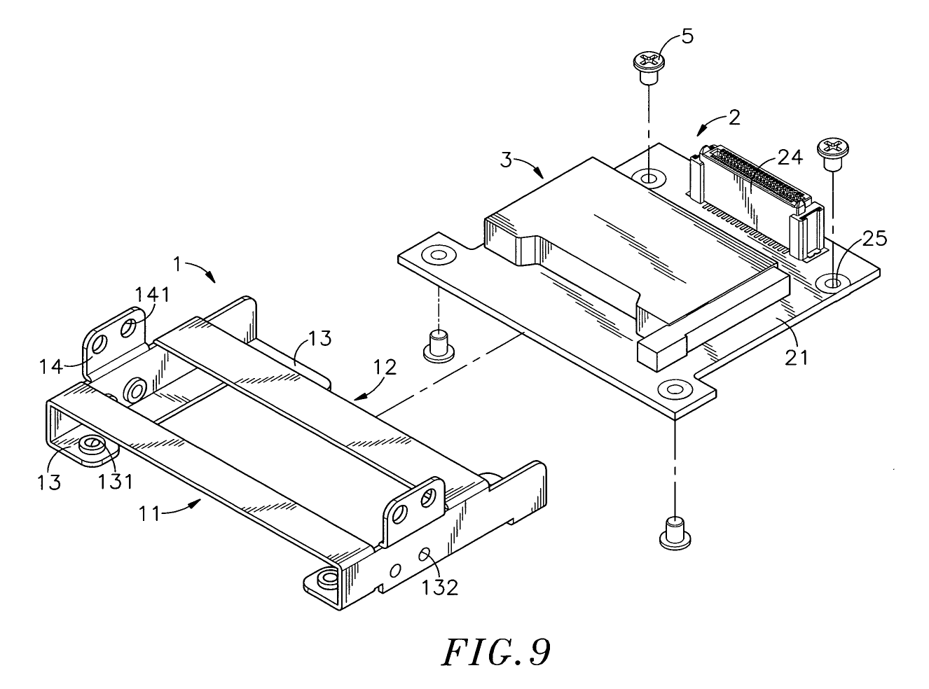

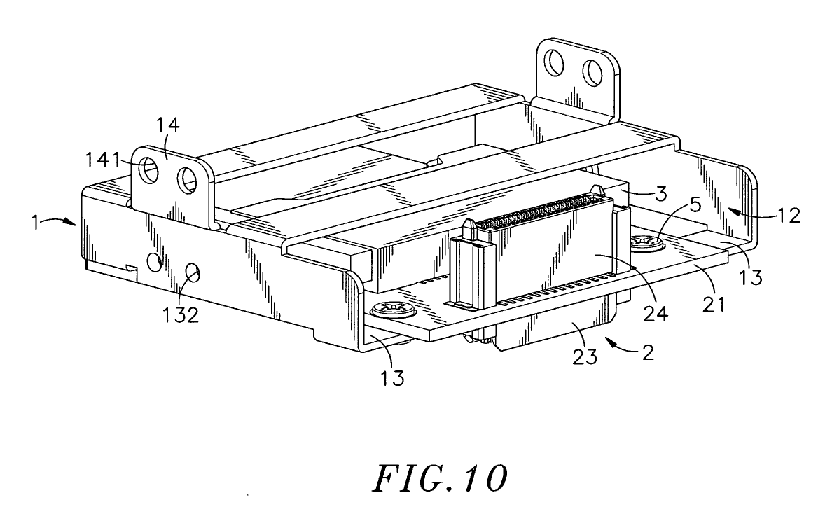

FIGS. 9 and 10 show a multi-stack storage module board assembly in accordance with a fourth embodiment of the present invention (the host board excluded). According to this third embodiment, the multimedia storage device 3 is a CF (Compact Flash) hard disk drive, and the bracket 1 fits a CF hard disk drive in shape, size and/or thickness. The multimedia storage device 3 is mounted on the adapter module 23 and electrically connected to the adapter module 2. The second connector 23 of the adapter module 2 is compatible to the third connector 24 so that the second connector 23 of one adapter module 2 can be electrically connected to the third connector 24 of another adapter module 2. Similar to the aforesaid first and second embodiments, the bracket 1 has two upright lugs 14 at two sides, and each upright lug 14 has two locating through holes 141. Thus, multiple brackets 1 can be connected in a stack to hold multiple multimedia storage devices 3 at different elevations. By means of the associating adapter modules 2, the stacked multimedia storage devices 3 are electrically connected to the host board (not shown).

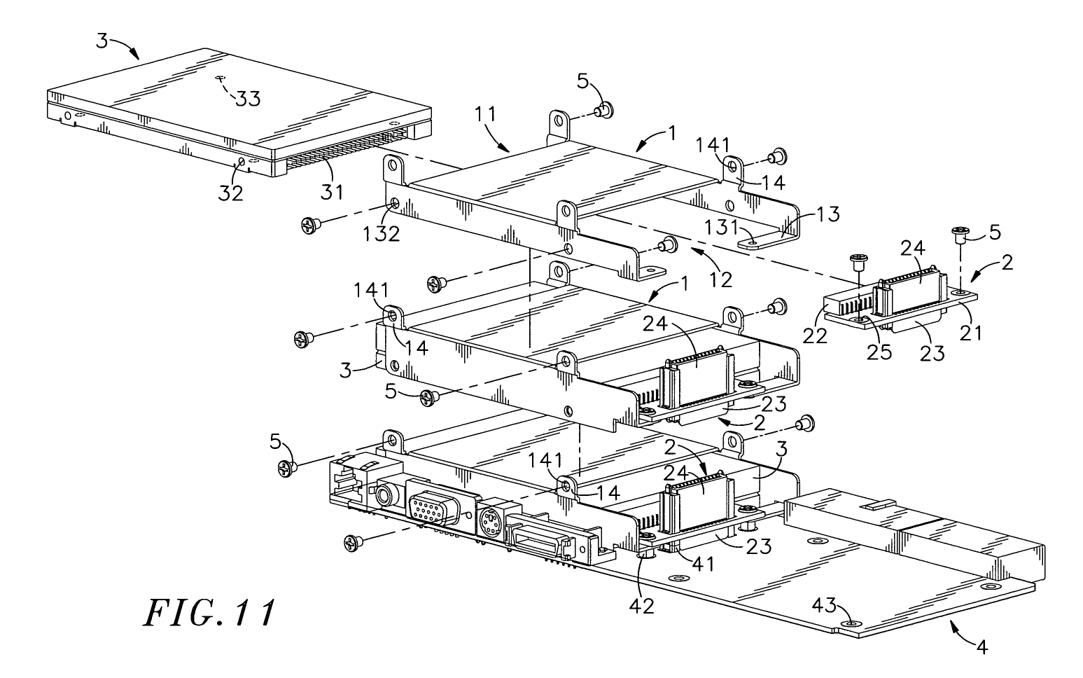

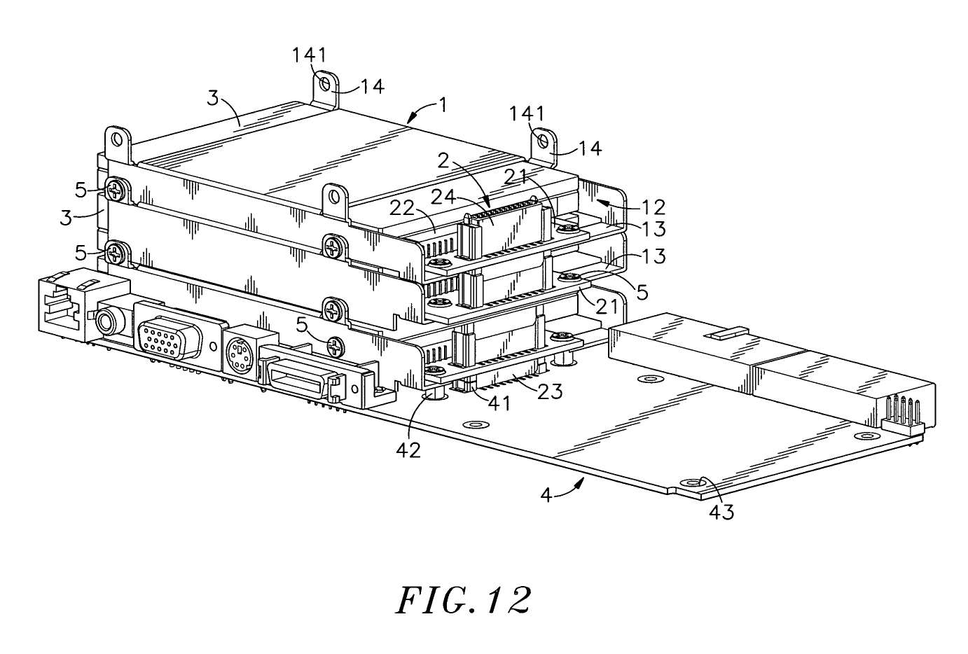

FIGS. 11 and 12 show a multi-stack storage module board assembly in accordance with a fifth embodiment of the present invention. According to this fifth embodiment, each multimedia storage device 3 can be a SAS or IDE hard disk drive, and each bracket 1 fits a SAS or IDE hard disk drive in shape, size and/or thickness. After connection of the respective multimedia storage devices 3 to the SAS or IDE interface type first connectors 22 of the associating adapter modules 2, the third connector 23 of one adapter module 2 is connected to the connector 41 of the host board 4 or the third connector 24 of another adapter module 2, and therefore the multimedia storage devices 3 are electrically connected to the host board 4, and the multiple brackets 1 are connected in a stack to hold the multiple multimedia storage devices 3 at different elevations.

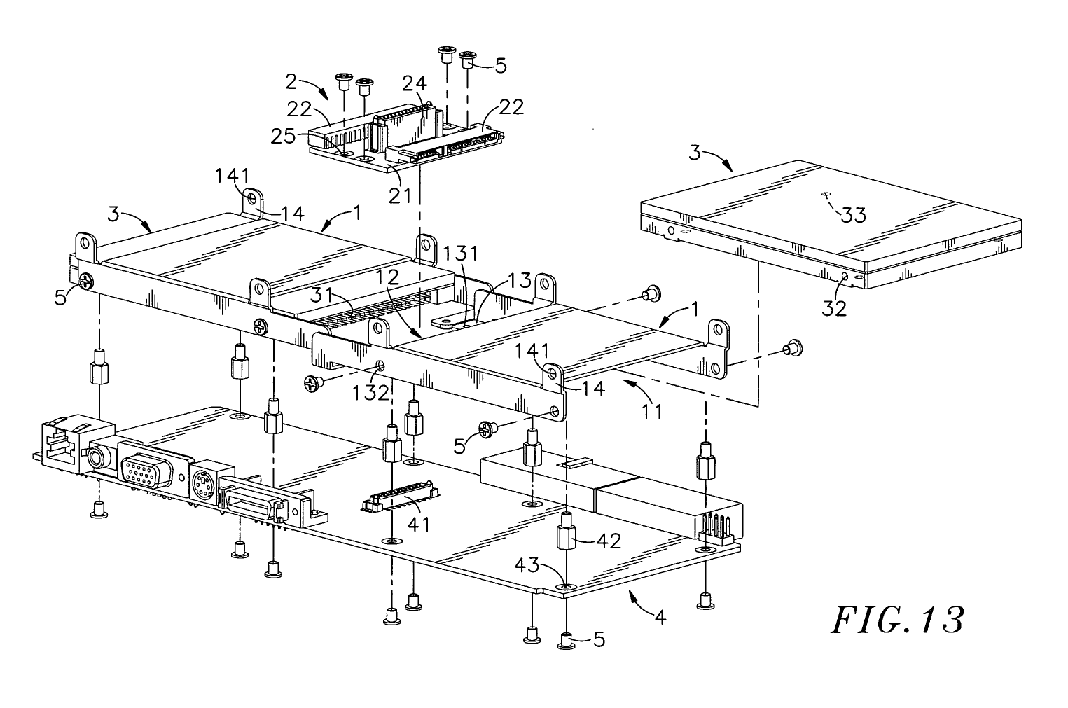

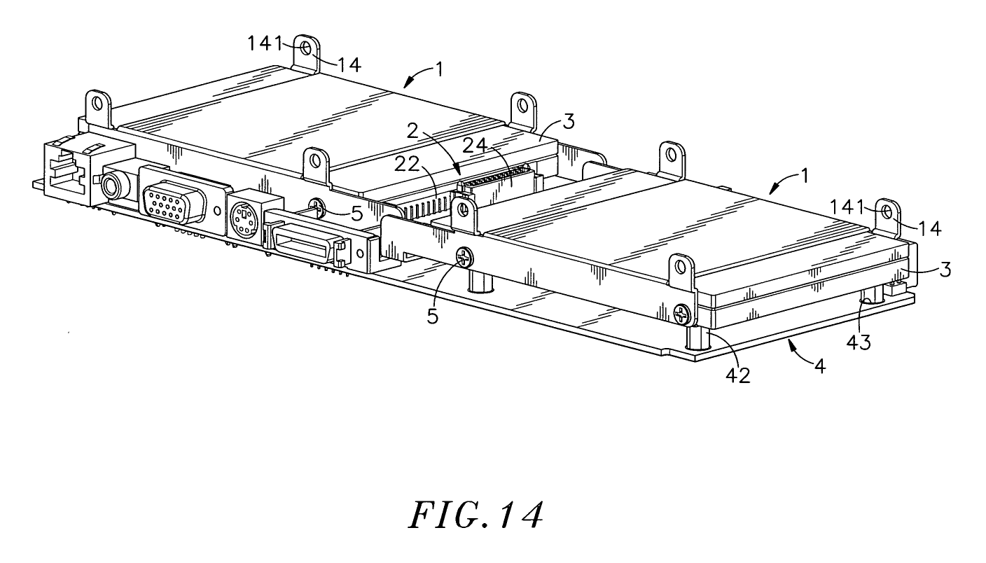

FIGS. 13 and 14 show a multi-stack storage module board assembly in accordance with a sixth embodiment of the present invention. According to this sixth embodiment, multi-stack storage module board assembly is comprised of a plurality of brackets 1, an adapter module 2, a plurality of multimedia storage devices 3 and a host board 4.

Same as the aforesaid various embodiments, each bracket 1 defines a first receiving space 11 for receiving one multimedia storage device 3 and a second receiving space 12 in communication with the first receiving space 11 at one side for receiving the adapter module 2. Further, each bracket 1 has a plurality of mounting holes 132 on two opposite sidewalls thereof, two support arms 13 respectively inwardly extending from one end of each of the two opposite sidewalls and suspending in the second receiving space 12 at the bottom, each support arm 13 having a mounting through hole 131, and a plurality of upright lugs 14 respectively upwardly extending from the two opposite sidewalls corresponding to the mounting holes 132, each upright lug 14 having a locating through hole 141.

The adapter module 2 comprises a printed circuit board 21, two first connectors 22 horizontally arranged on the top side of the printed circuit board 21 and extending outwards in reversed directions, a third connector 24 arranged on the top side of the printed circuit board 21 in vertical and spaced between the two first connectors 22, and a second connector 23 (not shown) arranged on the bottom side of the printed circuit board 21, and two pairs of through holes 25 cut through the printed circuit board 21.

The multimedia storage device 3 has a signal connector 31 disposed at one side for receiving one first connector 22 of the adapter module 2, a plurality of receiving holes 32 disposed at two sides corresponding to the mounting holes 132 of each bracket 1, and a plurality of locating holes 33 on the bottom side.

The host board 4 comprises a connector 41 for receiving the second connector 23 of the adapter module 2, a plurality of holes 43 corresponding to the locating holes 33 of the two multimedia storage devices 3, and a plurality of spacer supports 42 respectively engaged into the locating holes 33 of the multimedia storage devices 3 and fastened to the holes 43 to support the multimedia storage devices 3 above the host board 4.

During installation, the adapter module 2 is set in the second receiving spaces 12 of the two brackets 1 and supported on the support arms 13, and then fastening members 5 are fastened to the through holes 25 of the adapter module 2 and the mounting through hole 131 of the support arms 13 to affix the adapter module 2 to the two brackets 1, and then the two multimedia storage devices 3 are respectively inserted into the first receiving space 11 of each of the two brackets 1 to force the signal connectors 31 of the two multimedia storage devices 3 into connection with the first connectors 22 of the adapter module 2, and then fastening members 5 are fastened to the mounting holes 132 of the brackets 1 and the receiving holes 32 of the multimedia storage devices 3 to affix the multimedia storage devices 3 to the brackets 1, and then the spacer supports 42 are respectively inserted into the locating holes 33 of the multimedia storage devices 3, and then the second connector 23 of the adapter module 2 is connected to the connector 41 of the host board 4 and the spacer supports 42 are respectively attached to the holes 43, and then fastening members 5 are fastened to the holes 43 and the spacer supports 42 to affix the spacer supports 42 to the host board 4. When installed, the multimedia storage devices 3 are supported on the spacer supports 42 above the host board 4, and kept steadily in horizontal.

The first connectors 22 of the adapter module 2 can be IDE, SCSI, SATA, SATA-II, SAS or USB plugs. Each multimedia storage device 3 can be a floppy disk drive, hard disk drive, CD-ROM, CD-RW, tape drive or any of a variety of electronic devices that have a storage interface. When a hard disk drive is used, it can be a storage device with an IDE, SCSI, SATA, SATA-II, SAS or CF interface. Further, the brackets 1 fit the multimedia storage devices 3 in shape, size or thickness. The brackets 1 can also be made to hold any of a variety of the aforesaid different types of multimedia storage devices 3. The aforesaid fastening members 5 can be screws, rivets or other equivalent devices.

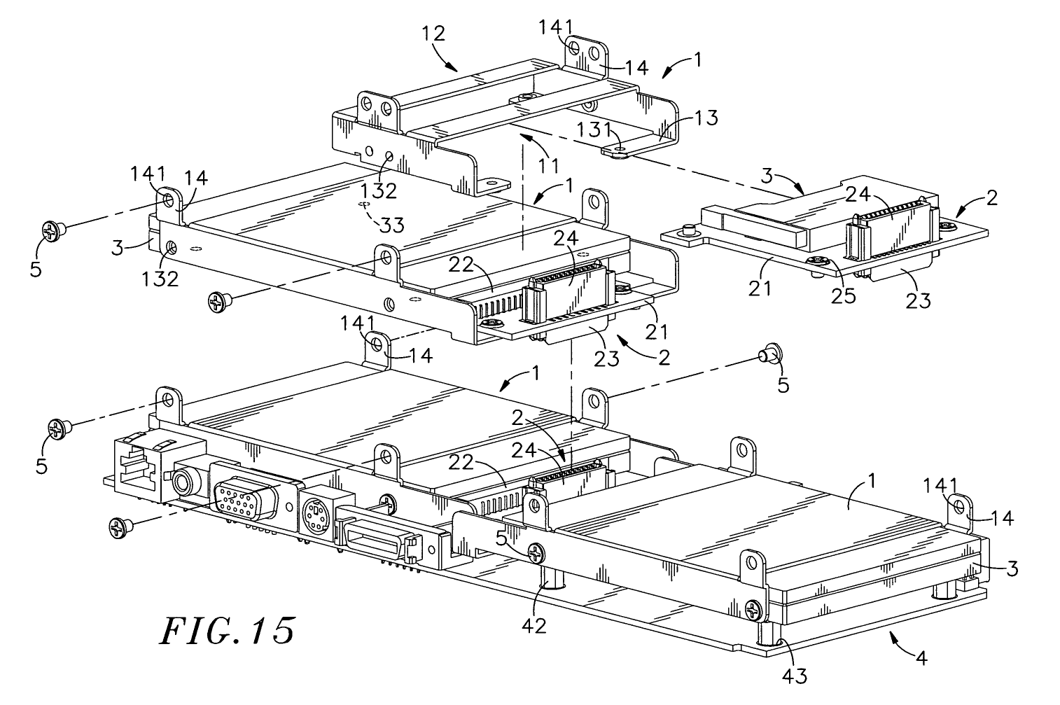

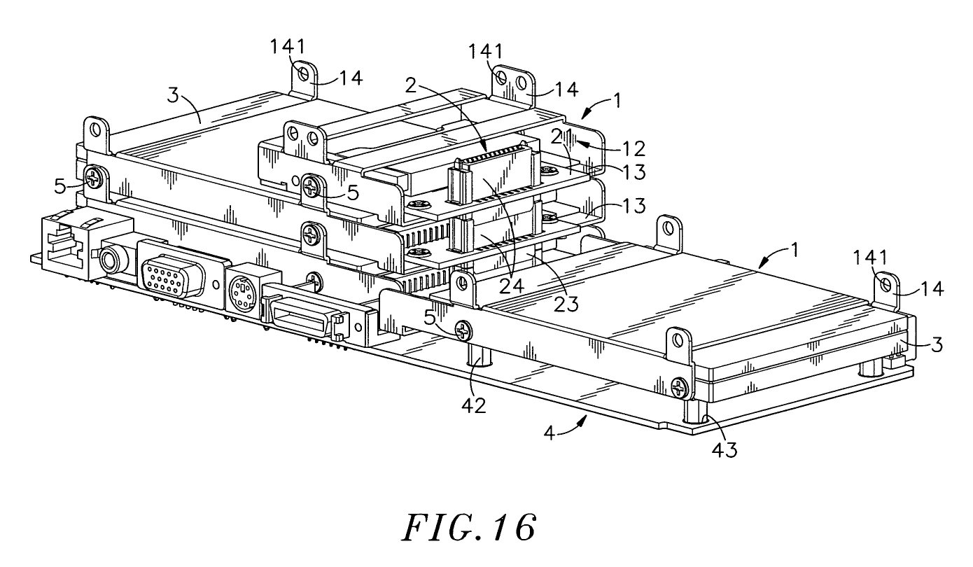

FIGS. 15 and 16 show a multi-stack storage module board assembly in accordance with a seventh embodiment of the present invention. According to this seventh embodiment, one adapter module 2 made according to the aforesaid sixth embodiment is mounted in between two brackets 1 and two multimedia storage devices 3 are mounted in the two brackets 1 and connected to the two first connectors 22 of the adapter module 2 and then mounted with the two brackets 1 and the adapter module 2 on the spacer supports 42 at the host board 4, and additional brackets 1 are connected to one of the two brackets 1 at the host board 4 in a stack to hold a respective multimedia storage device 3 and a respective adapter module 2, enabling the all adapter modules 2 to be connected to one another and to the connector 41 of the host board 4. Therefore, different specifications of multimedia storage devices 3 are arranged in a stack and electrically connected to the host board 4.

As indicated above, the invention provides a multi-stack storage module board assembly that has the following features:

1. The non-linear connection of the use of the adapter modules 2 eliminates the drawbacks of linear connection (the use of bus lines or cables has the problems of limitation of transmission efficiency and impedance interference; the used bus lines or cables may be tangled or stretched to affect or interrupt signal transmission), achieving rapid and stable transmission quality and high reliability.

2. Different multimedia storage devices 3 (floppy disk drive, hard disk drive, CD-ROM drive, tape player or any of a variety of other storage devices) can be selectively used and arranged on the host board 4 to fit different requirements and different installation space environments.

3. A number of different or same multimedia storage devices 3 can easily be installed in the host board 4 and steadily secured in place against vibration or displacement.

4. Multiple multimedia storage devices 3 can be arranged in a stack and connected to the connector 41 of the host board 4 by adapter modules 2, saving much installation space.

5. The invention allows one single host board 4 to support multiple multimedia storage devices 3, saving much the cost.

6. The optimal positioning and connecting design of the modularized multi-stack storage module board assembly facilitates system fabrication and assures high stability and reliability during assembly process or product operation.

Although particular embodiments of the invention have been described in detail for purposes of illustration, various modifications and enhancements may be made without departing from the spirit and scope of the invention. Accordingly, the invention is not to be limited except as by the appended claims

What the invention claimed is:

1. A multi-stack storage module board assembly comprising:
at least one bracket mounted on a host board, said at least one bracket each comprising a first receiving space for accommodating a multimedia storage device, a second receiving space in communication with said first receiving space at one side for accommodating an adapter module, two support arms bilaterally suspending in said second receiving space at a bottom side, and a plurality of mounting holes on two opposite lateral sides thereof;
at least one adapter module respectively mounted on the support arms in the second receiving space of said at least one bracket, said at least one adapter module each comprising a circuit board, at least one first connector horizontally mounted on a top side of said printed circuit board, and a second connector vertically downwardly disposed at a bottom side of said printed circuit board;
at least one multimedia storage device respectively mounted in the first receiving space of said at least one bracket and fastened to the mounting holes of said at least one bracket with fastening members, said at least one multimedia storage device each having a signal connector electrically connectable to the first connector of one of said at least one adapter module;
a host board, said host board comprising a connector, which receives the second connector of one of said at least one adapter module for enabling said host board to access to said at least one multimedia storage device.

2. The multi-stack storage module board assembly as claimed in claim 1, wherein said support arms of said at least one bracket each have at least one mounting through hole.

3. The multi-stack storage module board assembly as claimed in claim 1, wherein said at least one bracket each has a plurality of upright lugs corresponding to the mounting holes of the respective bracket such that the mounting holes of a first one of said at least one bracket are connectable to the upright lugs of a second one of said at least one bracket to hold the two brackets in a stack.

4. The multi-stack storage module board assembly as claimed in claim 1, wherein said at least one adapter module each further comprises a third connector vertically upwardly disposed at the top side of the respective printed circuit board, said third connector being compatible to said second connector.

5. The multi-stack storage module board assembly as claimed in claim 4, wherein said at least one adapter module includes at least two adapter modules connected in a stack by connecting the second connector of one of the adapter modules to the third connector of another one of the adapter modules to receive multiple multimedia storage devices at different elevations.

6. The multi-stack storage module board assembly as claimed in claim 1, wherein the printed circuit board of each of said at least one adapter module has a plurality of through holes for fastening to said support arms of said at least one bracket.

7. The multi-stack storage module board assembly as claimed in claim 1, wherein said at least one multimedia storage device each has a plurality of mounting holes disposed at two sides thereof and respectively fastened to the mounting holes of said bracket.

8. The multi-stack storage module board assembly as claimed in claim 1, wherein said host board comprises a plurality of holes, and a plurality of spacer supports respectively fastened to said holes for supporting said at least one multimedia storage device above said host board; said at least one multimedia storage device each has a plurality of bottom locating holes for fastening to said spacer supports.

9. The multi-stack storage module board assembly as claimed in claim 1, wherein said at least one bracket fits the associating multimedia storage device in shape, size and thickness.

10. The multi-stack storage module board assembly as claimed in claim 1, wherein each first connector of said at least one adapter module is one of IDE, SCSI, SATA, SATA-II, SAS and USB plugs.

11. The multi-stack storage module board assembly as claimed in claim 1, wherein said at least one multimedia storage device is respectively selected from one of floppy disk drive, hard disk drive, CD-ROM, CD-RW, tape drive and electronic device having a storage interface.

12. A multi-stack storage module board assembly comprising:
two brackets mounted on a host board in horizontal at two sides of the connector of said host board, said brackets each comprising a first receiving space for accommodating a multimedia storage device, a second receiving space in communication with said first receiving space at one side for accommodating an adapter module, two support arms bilaterally suspending in said second receiving space at a bottom side, and a plurality of mounting holes on two opposite lateral sides thereof;
an adapter module mounted on the support arms of said brackets within the second receiving space of each of said brackets, said adapter module comprising a printed circuit board, two first connectors horizontally mounted on a top side of said circuit board in reversed directions, and a second connector vertically downwardly disposed at a bottom side of said printed circuit board;
two multimedia storage devices respectively mounted in the first receiving space of each of said brackets and fastened to the mounting holes of said brackets with fastening members, said multimedia storage devices each having a signal connector electrically connectable to the first connectors of said adapter module;
a host board, said host board comprising an electric connector, which receives the second connector of said adapter board for allowing said host board to access to said multimedia storage device.

13. The multi-stack storage module board assembly as claimed in claim 12, wherein said support arms of said at least one bracket each have at least one mounting through hole.

14. The multi-stack storage module board assembly as claimed in claim 12, wherein said brackets each have a plurality of upright lugs corresponding to the mounting holes of the respective bracket for the mounting of a supplementary bracket to hold a supplementary multimedia storage device.

15. The multi-stack storage module board assembly as claimed in claim 12, wherein said adapter module each further comprises a third connector vertically upwardly disposed at the top side of the respective printed circuit board, said third connector being compatible to said second connector for receiving a supplementary adapter module.

16. The multi-stack storage module board assembly as claimed in claim 15, wherein said supplementary adapter module is connected to said adapter module to receive a supplementary multimedia storage devices above said two brackets, and said supplementary adapter module comprises a first connector arranged in horizontal for receiving a supplementary multimedia storage device and a second connector vertically downwardly disposed at a bottom side thereof and connected to the third connector of said adapter module.

17. The multi-stack storage module board assembly as claimed in claim 12, wherein the printed circuit board of said adapter module has a plurality of through holes for fastening to said support arms of said brackets.

18. The multi-stack storage module board assembly as claimed in claim 12, wherein said multimedia storage devices each have a plurality of receiving holes disposed at two sides thereof and respectively fastened to the mounting holes of said brackets.

19. The multi-stack storage module board assembly as claimed in claim 12, wherein said host board comprises a plurality of holes, and a plurality of spacer supports respectively fastened to said holes for supporting said multimedia storage devices above said host board; said multimedia storage devices each have a plurality of bottom locating holes respectively fastened to said spacer supports.

20. The multi-stack storage module board assembly as claimed in claim 12, wherein said brackets respectively fit said multimedia storage devices in shape, size and thickness.

21. The multi-stack storage module board assembly as claimed in claim 12, wherein the first connectors of said adapter module are respectively selected from one of IDE, SCSI, SATA, SATA-II, SAS and USB plugs.

22. The multi-stack storage module board assembly as claimed in claim 12, wherein said multimedia storage devices are respectively selected from one of floppy disk drive, hard disk drive, CD-ROM, CD-RW, tape drive and electronic device having a storage interface.
